(19) United States
(12) Patent Application Publication
(10) Pub. No.: US 2007/0076546 A1
(43) Pub. Date: Apr. 5, 2007

(54) Optical disc apparatus and tracking error signal selecting method

(76) Inventors: Tatsuro Shimizu, Yokohama-shi (JP); Kenji Takagi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/527,619

(22) Filed: Sep. 27, 2006

(30) Foreign Application Priority Data
Sep. 30, 2005 (JP) 2005-288953

(51) Int. Cl. G11B 7/00

(52) U.S. Cl. 369/44.29

(57) ABSTRACT

An optical disc apparatus comprises a driving unit which drives an optical pickup head (PUH) for irradiating laser light onto an optical disc in such a manner that laser light is irradiated onto a plurality of positions on the optical disc, a photodetector unit which outputs a photo sense signal on the basis of the reflected light from the optical disc onto which laser light is irradiated from the PUH, a signal generating unit which generates tracking error signals of a plurality of different methods on the basis of the photo sense signal, and a tracking error signal selecting unit which selects a tracking error signal of any one of the methods on the basis of the state of the tracking error signals of the plurality of methods generated in a plurality of different positions on the disc.

### CROSS-REFERENCE TO RELATED APPLICATIONS

This application is based upon and claims the benefit of priority from prior Japanese Patent Application No. 2005-288953, filed Sep. 30, 2005, the entire contents of which are incorporated herein by reference.

### BACKGROUND OF THE INVENTION

1. Field of the Invention

This invention relates to an optical disc apparatus which detects a tracking error signal used in a tracking servo from an optical disc and a tracking error signal selecting method in the optical disc apparatus.

2. Description of the Related Art

As a method of determining the type of a disc inserted into an optical disc apparatus, a method of making a determination by reading previously recorded data in a control data zone or the like can be considered. To read the previously recorded data, the track has to be captured in advance by turning on the focus servo and tracking servo. To capture the track, it is necessary to obtain a sufficiently stable tracking error signal in advance.

For example, tracking error signals used in recording and reproducing data onto and from a Digital Versatile Disc (DVD) are principally of two types: the differential phase detection (DPD) method and the differential push-pull (DPP) method. Tracking error signals of the two methods differ in the state, depending on the type and state (finalized/unfinalized) of the disc or on the detecting position (or the radial position). For example, both tracking error signals may be effective or only one tracking error signal may be effective.

Therefore, according to the type and state of the disc inserted in the optical disc apparatus and to the detecting position, a tracking error signal suitable for a tracking servo has to be selected.

However, when the optical disc apparatus can handle a plurality of optical discs, it is very difficult to determine which of the two tracking error signals should be selected unless the type and state of the installed optical disc have been determined.

For example, even if the DPD tracking error signal detected in a certain radial position on the installed optical disc is effective, it is ineffective in another radial position, with the result that it may not be a suitable tracking error signal.

When an unsuitable tracking error signal has been selected, the problem of coming off the track, being unable to read data, or the like will arise, seriously worsening the performance.

In a conventional optical disc system which records and reproduces a plurality of recordable discs differing in track pitch, a method has been considered which distinguishes the types of optical discs differing in track pitch by detecting a plurality of distinction signals during the time when the objective lens is moved upward or downward and at the same time, is moved in the radial direction of the disc and then using the detected distinction signals (including a tracking error signal, a focus error signal and/or a sum signal of light-receiving elements) (refer to Jpn. Pat. Appln. KOKAI Publication No. 2005-32424).

### BRIEF SUMMARY OF THE INVENTION

According to an aspect of the present invention, there is provided: an optical disk apparatus which reproduces and records information by causing an optical pickup head to irradiate laser light onto an optical disk on which tracks have been formed, the optical disk apparatus comprising: light detecting unit configured to output a light detecting signal on the basis of the reflected light from the optical disk caused by the laser light irradiated by the optical pickup head; a plurality of tracking error signal generating unit configured to generate a plurality of tracking error signals by different methods on the basis of the light detecting signal output from the light detecting unit; driving configured to drive the optical pickup head in such a manner that the laser light is irradiated to different positions on the optical disk; and control configured to select a tracking error signal that fulfills a specific condition from said plurality of tracking error signals in the different methods generated by said plurality of tracking error signal generating unit for each of the different positions on the optical disk and performing tracking control using the selected tracking error signal.

According to another aspect of the present invention, there is provided a tracking error signal selecting method for an optical disk apparatus comprising: a first tracking error signal generating step of causing an optical pickup head to irradiate laser light to a first position on an optical disk and generating a plurality of tracking error signals by different methods from a light detecting signal obtained by detecting the reflected light from the optical disk; a step of driving the optical pickup head to a second position located in the direction of the radius of the optical disk with respect to the first position on the optical disk; a second tracking error signal generating step of causing the optical pickup head to irradiate laser light to the second position on the optical disk and generating a plurality of tracking error signals by the different methods from the light detecting signal obtained by detecting the reflected light from the optical disk; and a step of selecting a tracking error signal that fulfills a specific condition from said plurality of tracking error signals obtained in the first and second tracking error signal generating steps and performing tracking control using the selected tracking error signal.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an optical disc apparatus according to an embodiment of the present invention;

FIG. 2 shows the position of a physical format information area on a typical disc used in the optical disc apparatus of the embodiment and a tracking error signal generated in each area;

FIG. 3 is a flowchart to help explain the processing from when a disc is inserted into the optical disc apparatus of the embodiment until data reading is done;

FIG. 4 is a flowchart to help explain in detail a tracking error type selecting process (step A5) in the embodiment;

FIGS. 5A and 5B are diagrams to help explain a state where an optical pickup head 11 is tilted by an actuator 23 (or a radial tilt actuator);

FIG. 6 is a flowchart to help explain an error signal determining process in the embodiment;

FIG. 7 is a flowchart to help explain a tracking error type selecting process of selecting a tracking error signal on the basis of the state of tracking error signals generated in three places in the embodiment; and

FIG. 8 shows the relationship between the result of determining the tracking error signals generated in three places and the method of the selected tracking error signal in the embodiment.

### DETAILED DESCRIPTION OF THE INVENTION

Hereinafter, referring to the accompanying drawings, an embodiment of the present invention will be explained.

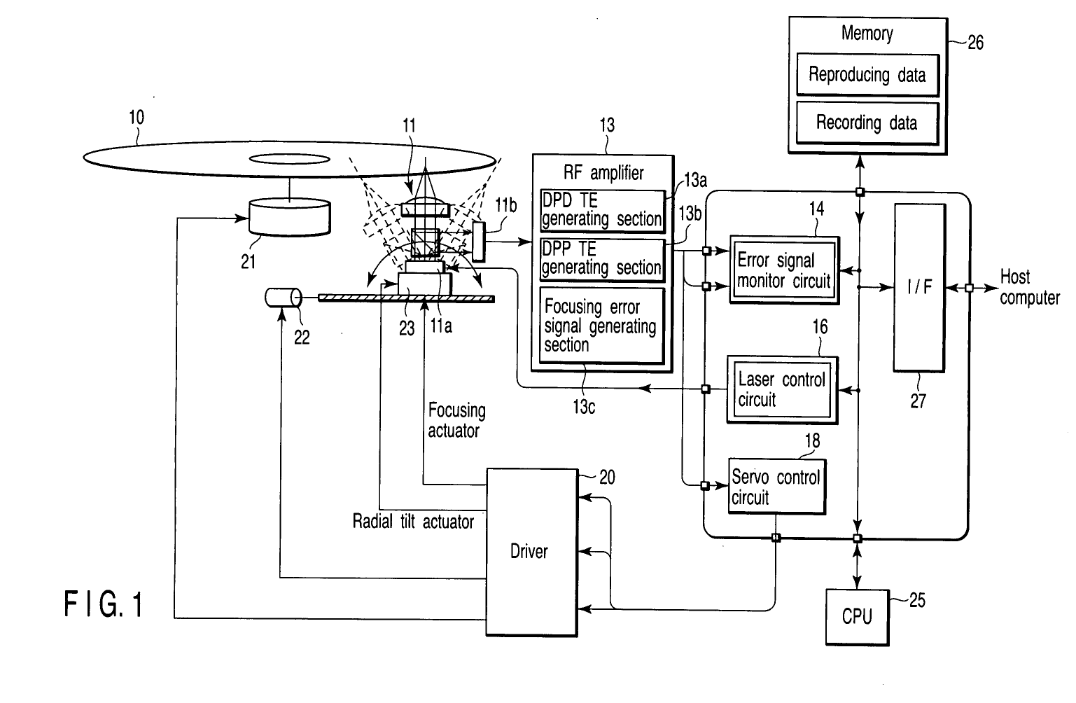

FIG. 1 is a block diagram showing the configuration of an optical disc apparatus of the embodiment.

An optical disc 10 serving as a recording medium, which has a spiral track, is rotated by a spindle motor 21. Suppose, for example, Compact Disc (CD) and Digital Versatile Disc (DVD) can be used as the optical disc 10 in the optical disc apparatus of the embodiment.

Information is recorded and reproduced onto and from the optical disc 10 with laser light output from an optical pickup head (PUH) 11.

The optical pickup head 11 includes a laser diode 11a, a collimator lens, a beam splitter, an objective lens, a cylindrical lens, a photodetector 11b, and a lens position sensor and so on.

The laser diode 11a outputs laser light under the control of a laser control circuit 16. The optical disc apparatus of the embodiment is provided with a plurality of laser diodes 11a that output lasers of different wavelengths. Depending on the type of the optical disc 10 inserted (for example, CD or DVD), the optical disc apparatus outputs laser light. As for DVD, suppose the optical disc apparatus can handle not only a DVD (such as DVD-RAM) using red laser light but also an HD-DVD using blue laser light.

The laser light output from the laser diode 11a passes through the collimator lens, beam splitter, and objective lens and is irradiated onto the optical disc 10. The reflected light from the optical disc 10 passes through the objective lens, beam splitter, and cylindrical lens and is directed to the photodetector 11b. The photodetector 11b, which is composed of, for example, quadrant photodetector cells, outputs the sense signals of these photodetector cells to an RF amplifier 13.

The RF amplifier 13 processes the signals from the photodetectors 11b and outputs the resulting signal. The RF amplifier 13 includes a differential phase detection (DPD) tracking error signal generating section 13a and a differential push-pull (DPP) tracking error signal generating section 13b which generate a tracking error signal that indicates the difference between the center of the beam spot of laser light and the center of the track and a focus error signal generating section 13c that generates a focus error signal indicating the difference from the just focus.

The DPD tracking error signal generating section 13a generates a tracking error signal by the DPD method. It generates a DPD tracking error signal by making use of changes in the sense signals of the quadrant photodetector cells supplied from the photodetector 11b.

The DPP tracking error signal generating section 13b generates a tracking error signal by the DPP method. It generates a DPP tracking error signal from the difference in intensity between the right and left sense signals of the quadrant photodiode cells supplied from the photodetector 11b.

The tracking error signals generated by the DPD tracking error signal generating section 13a and DPP tracking error signal generating section 13b are supplied to an error signal monitor circuit 14. The error signal monitor circuit 14 measures the tracking error signals generated by the two methods. It determines whether there is an RF signal (or a tracking error signal) in an error signal determining process explained later and further determines the amplitude of the tracking error signal. When determining the amplitude of the tracking error signal, the error signal monitor circuit 14 determines whether the amplitude is larger than, for example, a predetermined threshold value.

On the other hand, the tracking error signal and focus error signal output from the RF amplifier 13 are supplied to a servo control circuit 18.

The servo control circuit 18 causes a driver 20 to drive an actuator 23 (or a focusing actuator) according to the focus error signal, thereby achieving a focus servo so that laser light output from the optical pickup head 11 may be just focused on the recording film of the optical disc 10.

Moreover, according to a suitable tracking error signal selected in a tracking error type selecting process from the tracking error signals output from the DPD tracking error signal generating section 13a and DPP tracking error signal generating section 13b, the servo control circuit 18 causes the driver 20 to drive a sled motor 22 and an actuator 23 (or a tracking/radial tilt actuator), thereby achieving a tracking servo so that laser light output from the optical pickup head 11 may always trace the track formed on the optical disc 10.

Under the control of the servo control circuit 18, the driver 20 drives the spindle motor 21 that rotates the optical disc 10, the sled motor 22 that moves the optical pickup head 11 in the radial direction (or the tracking direction), and the actuator 23. The actuator 23 includes a focusing actuator that moves the laser light from the optical pickup head 11 in the focusing direction (or along the optical axis of the lens) and a tracking actuator that moves the laser light in the radial direction, or a radial tilt actuator that tilts the laser light in the radial direction.

A CPU 25 provides comprehensive control of the entire apparatus by using a memory 26 (RAM area) as a work area. On the basis of a program stored in the memory 26 (ROM area), the CPU 25 controls each section according to an operation command supplied from a host computer via an interface circuit 27. In the embodiment, a tracking error type selecting process is carried out which selects a suitable tracking error signal used in a tracking servo from the tracking error signals generated by a plurality of methods, with laser light being just focused on the optical disc 10 inserted in the optical disc apparatus. (A detailed explanation will be given with reference to FIG. 4.)

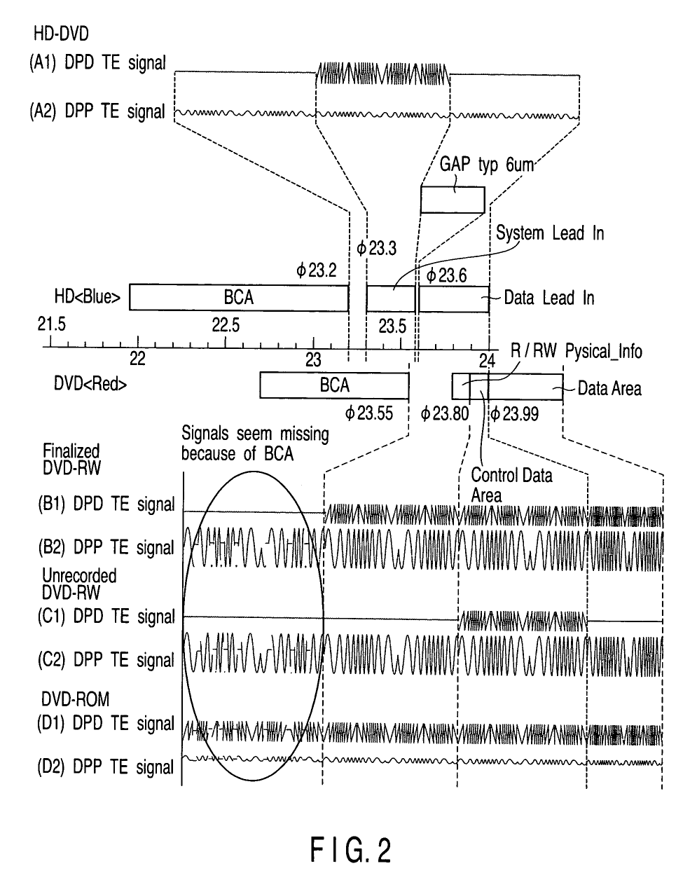

FIG. 2 shows the position of a physical format information area on a typical disc used in the optical disc apparatus of the embodiment and a tracking error signal generated in each area of the disc.

FIG. 2 shows an example of an HD-DVD using a blue laser and a DVD (such as a finalized DVD-RW, an unrecorded DVD-RW, or a DVD-ROM) using a red laser. The left side of FIG. 2 corresponds to the center of the disc (that is, the right side corresponds to the outer edge).

FIG. 2(A1) shows a tracking error signal generated by the DPD method obtained from an HD-DVD and FIG. 2(A2) shows a tracking error signal generated by the DPP method.

Similarly, FIG. 2(B1) shows a tracking error signal generated by the DPD method obtained from a finalized DVD-RW and FIG. 2(B2) shows a tracking error signal generated by the DPP method. FIG. 2(C1) shows a tracking error signal generated by the DPD method obtained from an unrecorded DVD-RW and FIG. 2(C2) shows a tracking error signal generated by the DPP method. FIG. 2(D1) shows a tracking error signal generated by the DPD method obtained from a DVD-ROM and FIG. 2(D2) shows a tracking error signal generated by the DPP method.

As shown in FIG. 2, the state of the tracking error signal differs, depending on the type and state (finalized/unfinalized) of the disc or the detecting position (or radial position). For example, in a radial position corresponding to the Control Data area of a DVD, both of the DPD and DPP tracking error signals are generated in a finalized DVD-RW and in an unrecorded DVD-RW. In a DVD-ROM, only one of the DPD and DPP tracking error signals (specifically, DPD) is generated. In the same position on an HD-DVD, no tracking error signal is obtained.

Furthermore, even if both of the DPD and DPP tracking error signals are generated in the Control Data area in a finalized DVD-RW and in an unrecorded DVD-RW, no DPD tracking error signal won't be generated outside the Control Data area of the unrecorded DVD-RW.

As described above, since the state of the tracking error signal differs, depending on the type and state of the disc or the detecting position, it is difficult to determine which of the tracking error signals of the two methods is suitable for a tracking servo unless the type and state of the installed optical disc has been decided. In the optical disc apparatus of the embodiment, the state of a tracking error signal generated by each method obtained in a plurality of places in the radial direction of the inserted disc is observed and, on the basis of the state, the best tracking error signal is selected by a tracking error type selecting process explained below.

Next, the operation of the optical disc apparatus of the embodiment will be explained with reference to a flowchart.

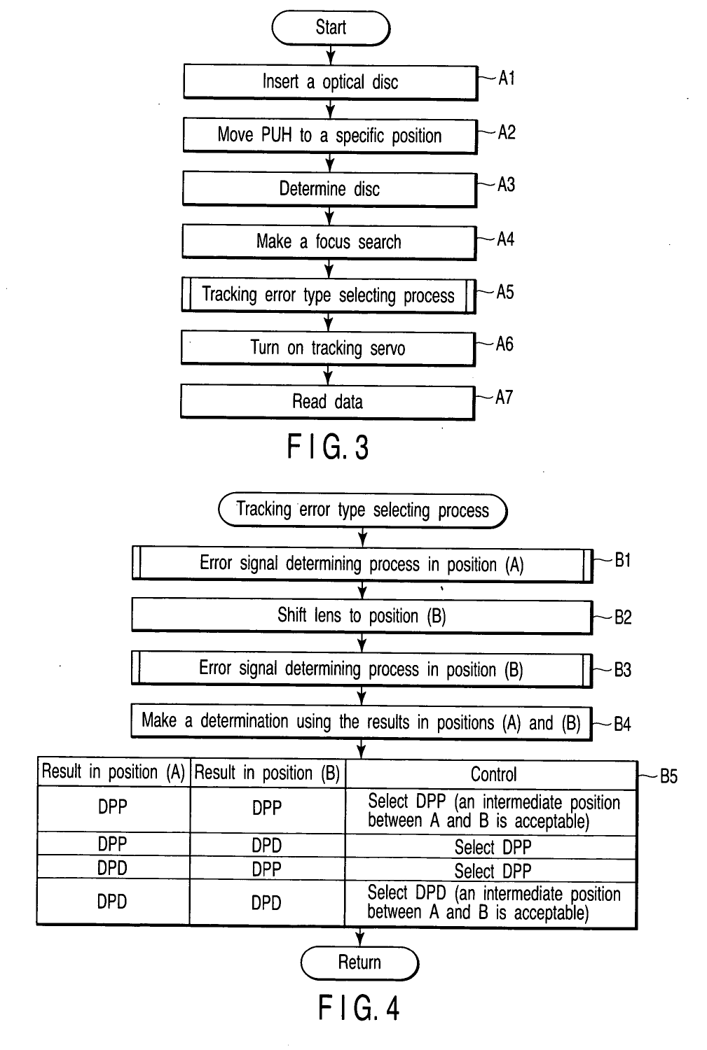

FIG. 3 is a flowchart to help explain the processing from when the optical disc is inserted into the optical disc apparatus until data reading is done.

First, when having sensed that the optical disc 10 has been inserted (step A1), the CPU 25 causes the driver 20 to drive the sled motor 22, thereby moving the optical pickup head 11 to a specific position (step A2). Then, in this position, the optical pickup head 11 irradiates laser light to the inserted optical disc 10 and determines the type of the disc, or determines which of the three types CD, DVD, and HD-DVD the disc belongs to, from the sense signal generated according to the reflected light from the optical disc 10.

For example, in determining whether the disc belongs to the CD-family discs, DVD-family discs, or HD-DVD family discs, the fact that the wavelength of laser light capable of reading data differs, depending on the type of the disc is used. Laser light to be irradiated onto the optical disc 10 from the optical pickup head 11 is selected and the reflectivity and the like are corrected according to the disc for the reflected light from the optical disc, thereby determining laser light with which data can be read. As a result of the determination, the type of the inserted disc is determined.

Suppose the initial position of the optical pickup head 11 is determined to be a position where there is a strong possibility that the best tracking error signal can be selected according to the difference between the optical discs, excluding the burst cutting area (BCA) from which a signal is missing.

Next, the driver 20 drives the actuator 23 (or focusing actuator) to make a focus search, thereby turning on a focus servo (or make a focus servo closed-loop) (step A4).

Next, the CPU 25 carries out the tracking error type selecting process and selects a tracking error signal generated by either the DPD or DPP method used in tracking the inserted optical disc 10 (step A5). The tracking error type selecting process will be explained later in detail (see FIG. 4).

When a tracking error signal of either method has been selected in the tracking error type selecting process, the servo control circuit 18 performs tracking (or makes the tracking servo closed-loop) according to the tracking error signal (step A6).

In this way, with the focus servo and tracking servo in the on state, the recoded data on the inserted optical disc 10 is read (step A7). This makes it possible to finally determine the type of the optical disc 10.

Next, the tracking error type selecting process (step A5) in the embodiment will be explained in detail with reference to a flowchart shown in FIG. 4.

The flowchart of FIG. 4 shows a case where a determination is made on the basis of the state of the tracking error signal generated in two places of the optical disc 10. In the embodiment, the actuator 23 (or radial tilt actuator) tilts the optical pickup head 11, thereby irradiating laser light output from the optical pickup head 11 onto a plurality of places of the optical disc 10.

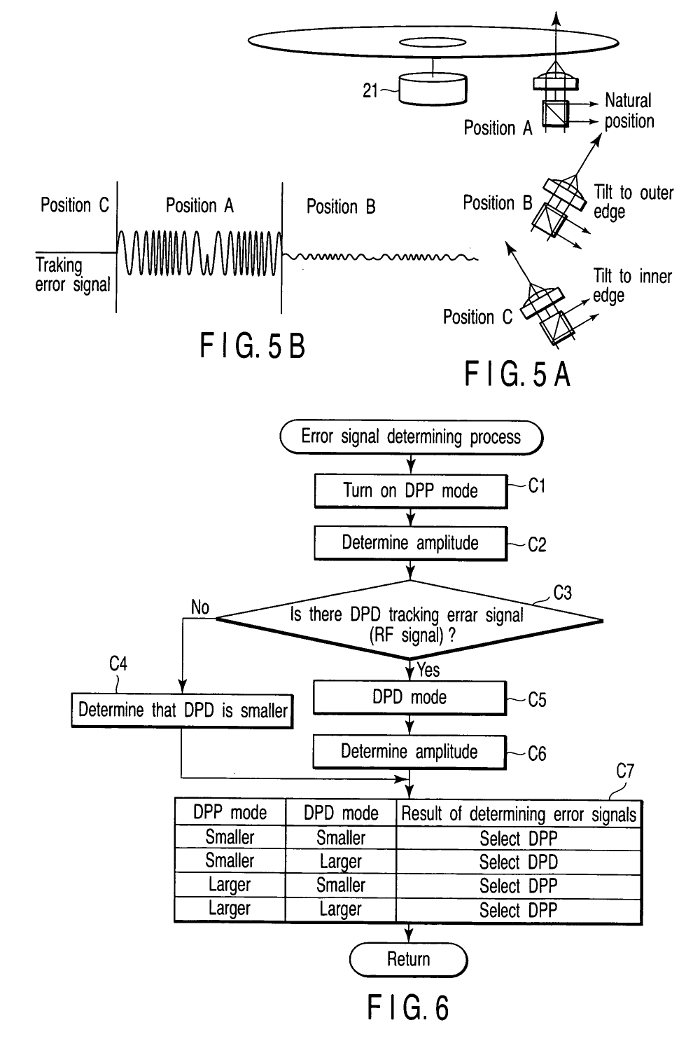

FIGS. 5A and 5B are diagrams to help explain a state where the optical pickup head 11 is tilted by the actuator 23 (or radial tilt actuator).

In FIG. 5A, when the optical pickup head 11 is not tilted by the actuator 23 (or radial tilt actuator) and is in a natural position, let a position on the optical disc 10 onto which laser light from the optical pickup head 11 is irradiated be position (A). When the optical pickup head 11 is tilted to the outer edge of the disc by the actuator 23 (or radial tilt actuator), let a position on the optical disc 10 onto which the laser light is irradiated be position (B). In this case, position (B) is closer to the outer edge than position (A). Moreover, when the optical pickup head 11 is tilted from the natural position to the inner edge by the actuator 23 (or radial tilt actuator), let a position on the optical disc 10 onto which the laser light is irradiated be position (C). Position (C) is closer to the inner edge than position (A).

As shown in FIG. 5B, for example, even when a stable tracking error signal is obtained in position (A), only an unstable tracking error signal of small amplitude is obtained in position (B). Moreover, in position (C), a tracking error signal may not be obtained. In the embodiment, the optical pickup head 11 is tilted by the actuator 23 (or radial tilt actuator), thereby detecting tracking error signals in a plurality of places.

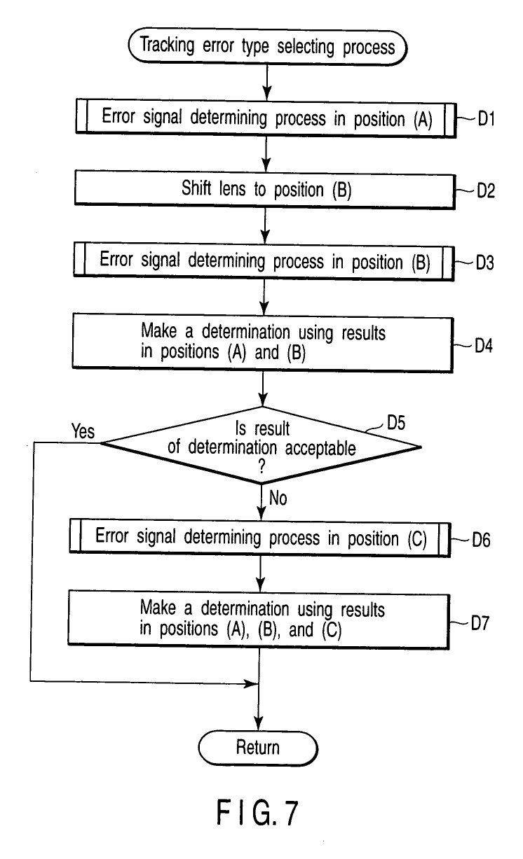

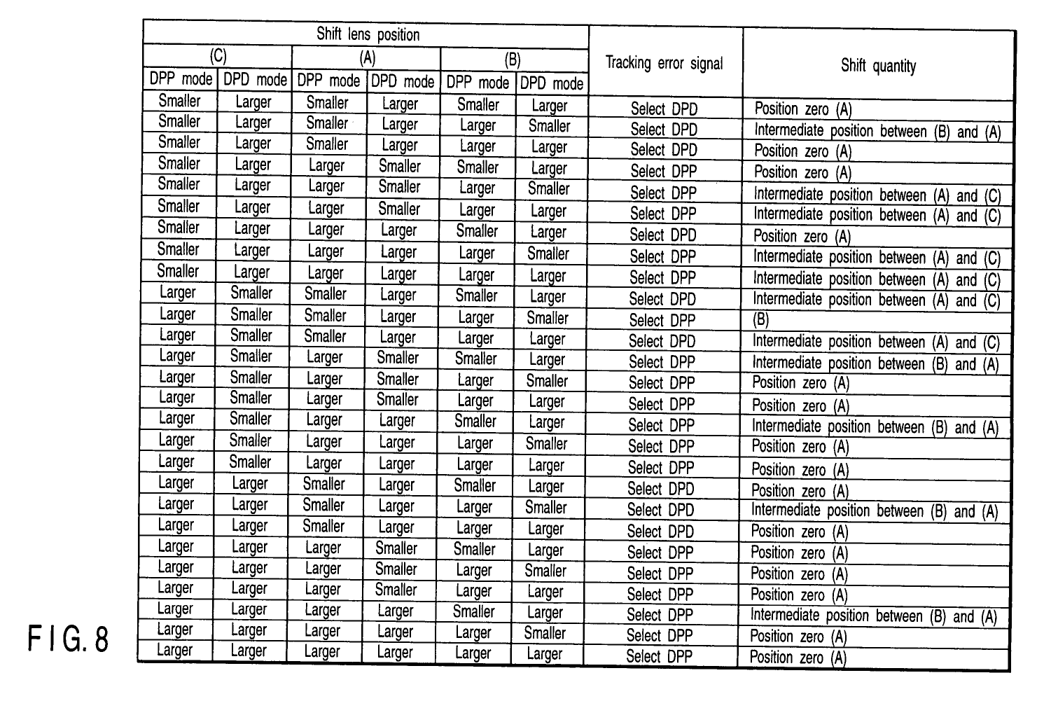

In the flowchart of FIG. 4, explanation will be given using a case where tracking error signals are detected in two places, position (A) and position (B). (A tracking error type selecting process using position (C) will be described later using FIGS. 7 and 8.)

First, on the basis of the photo sense signal detected in position (A), the CPU 25 carries out an error signal determining process of determining the state of a DPD tracking error signal and a DPP tracking error signal generated at the DPD tracking error signal generating section 13a and the DPP tracking error signal generating section 13b (step B1).

FIG. 6 is a flowchart to help explain an error signal determining process in the embodiment.

First, in the error signal determining process, the DPP mode is turned on (step C1). Specifically, the error signal monitor circuit 14 determines the amplitude of a tracking error signal generated by the DPP tracking error signal generating section 13b on the basis of the photo sense signal output from the photodetector 11b.

The error signal monitor circuit 14 compares the tracking error signal generated by the DPP method with a predetermined threshold value (or a first threshold value) and determines whether the amplitude of the tracking error signal is larger than the threshold value. The CPU 25 stores in the memory 26 the result of the determination by the error signal monitor circuit 14, that is, data indicating whether the amplitude is larger or smaller than the threshold value (step C2). Here, the result of the determination is stored together with the level.

Next, control proceeds to the determination of a tracking error signal of the DPD method. When the error signal monitor circuit 14 has sensed that there is no DPD tracking error signal (RF signal) from the DPD tracking error signal generating section 13a (No in step C3), the CPU 25 determines that the result of determining the DPD tracking error signal has shown that the amplitude is not larger than the threshold value and stores data indicating that the amplitude is smaller than the threshold value into the memory 26 (step C4).

On the other hand, when there is a DPD tracking error signal, the DPD mode is turned on. Then, the error signal monitor circuit 14 determines the amplitude of the tracking error signal generated by the DPD tracking error signal generating section 13a.

The error signal monitor circuit 14 compares the tracking error signal generated by the DPP method with a predetermined threshold value (or a second threshold value) and determines whether the amplitude of the tracking error signal is larger than the threshold value. The CPU 25 stores in the memory 26 the result of the determination by the error signal monitor circuit 14, that is, data indicating whether the amplitude is larger or smaller than the threshold value (step C6). Here, the result of the determination is stored together with the level.

The first threshold value for determining a DPP tracking error signal and the second threshold value for determining a DPD tracking error signal may be made different from each other to make an appropriate determination of the respective signals.

Having obtained the result of determining the amplitude of each of the DPP and DPD tracking error signals, the CPU 25 determines which of the DPP and DPD tracking error signals is suitable for position (A) (step C7).

In the example of FIG. 6, if the result of the determination in the DPP mode has shown that the amplitude is smaller than the threshold value and the result of the determination in the DPD mode has shown that the amplitude is smaller than the threshold value, the DPP tracking error signal is selected. Similarly, if the result of the determination in the DPP mode has shown that the amplitude is smaller than the threshold value and the result of the determination in the DPD mode has shown that the amplitude is larger than the threshold value, the DPD tracking error signal is selected. If the result of the determination in the DPP mode has shown that the amplitude is larger than the threshold value and the result of the determination in the DPD mode has shown that the amplitude is smaller than the threshold value, the DPP tracking error signal is selected. If the result of the determination in the DPP mode has shown that the amplitude is larger than the threshold value and the result of the determination in the DPD mode has shown that the amplitude is larger than the threshold value, the DPP tracking error signal is selected.

In the result of the determination shown in FIG. 6, when the result of the determination in the DPP mode and the result of the determination in the DPD mode meet specific conditions, a tracking error signal by a predetermined specific method is supposed to be selected. That is, if the result of the determination in the DPP mode identities from the result of the determination in the DPD mode, the DPP tracking error signal is supposed to be selected.

If different results of the determination have been obtained for two tracking error signals, one of the signals cannot be selected on the basis of the results. Therefore, in this case, the DPP tracking error signal is selected because there is a good chance that it is the best tracking error signal.

In this way, after the error signal determining process in position (A) has been completed, the CPU 25 causes the driver 20 to drive the actuator 23 (or radial tilt actuator), thereby changing the optical pickup head 11 irradiating position to position (B) (step B2).

Here, on the basis of the photo sense signal detected in position (B), the CPU 25 carries out an error signal determining process of determining the states of a DPD tracking error signal and a DPP tracking error signal generated at the DPD tracking error signal generating section 13a and the DPP tracking error signal generating section 13b (step B3). The error signal determining process in position (B) is supposed to be carried out in the same manner as in position (A) and its detailed explanation will not be given (see FIG. 6).

After the error signal determining process in position (B) has been completed, the CPU 25 determines the best method for a tracking error signal in the present position of the optical pickup head 11 on the basis of the result of determining the tracking error signals in position (A) and position (B) (step B4 and step B5).

In the example of FIG. 4, if the result of the determination in position (A) has shown DPP and the result of the determination in position (B) has shown DPP, the DPP tracking error signal is selected. Similarly, if the result of the determination in position (A) has shown DPP and the result of the determination in position (B) has shown DPD, a DPD tracking error signal is selected. If the result of the determination in position (A) has shown DPD and the result of the determination in position (B) has shown DPP, a DPP tracking error signal is selected. If the result of the determination in position (A) has shown DPD and the result of the determination in position (B) has shown DPD, a DPP tracking error signal is selected.

In the result of the determination shown in FIG. 4, when the result of the determination in position (A) and the result of the determination in position (B) do not meet specific conditions (or do not coincide with each other), a tracking error signal of a predetermined specific method is supposed to be selected. That is, if the result of the determination in position (A) differs from the result of the determination in position (B), a DPP tracking error signal is supposed to be selected.

When a tracking error signal of either method has been selected in the tracking error type selecting process, the servo control circuit 18 does tracking according to the tracking error signal.

As described above, since a tracking error signal generated by either the DPP method or the DPP method is selected on the basis of the state of the tracking error signals generated in a plurality of places in the radial direction of the optical disc 10, even if the optical disc 10 inserted in the optical disc apparatus differs in the type and state (finalized/unfinalized) or the detecting position (or the radial position), a suitable tracking error signal can be selected reliably. Therefore, the stability of the tracking servo can be improved.

When the result of determination in position (A) is the same as that in position (B), the actuator 23 (or radial tilt actuator) may be driven in such a manner that the optical pickup head 11 irradiates laser light onto to any position (e.g., the midpoint) between position (A) and position (B) and then tracking may be done using the tracking error signal detected in that position. That is, when the result of the determination in position (A) is the same as that in position (B), if the same determination is made anywhere between position (A) and position (B), it is certain that the result of the determination in position (A) is the same as that in position (B). Therefore, use of the tracking error signal detected anywhere between position (A) and position (B) makes it possible to expect more stable tracking.

While in the explanation, a tracking error signal has been selected on the basis of the state of the tracking error signals generated in two places, position (A) and position (B) shown in FIG. 5, a tracking error signal may be selected on the basis of the tracking error signals generated in three or more places.

FIG. 7 is a flowchart to help explain a tracking error type selecting process of selecting a tracking error signal on the basis of the state of tracking error signals generated in three places shown in FIG. 5.

Since the processes shown in step D1 to step D4 of FIG. 7 are almost the same as step B1 to step B4 of FIG. 4, a detailed explanation of them will be omitted.

In the tracking error type selecting process of FIG. 4, if the result of the determination in position (A) differs from that in position (B), a tracking error signal of the predetermined DPP method is supposed to be selected.

In FIG. 7, if the result of the determination in position (A) differs from that in position (B), the CPU 25 determines that the tracking error signal of either method cannot be selected (No in step D5) and further causes the driver 20 to drive the actuator 23 (or radial tilt actuator) to change the optical pickup head 11 irradiating position to position (C), thereby carrying out an error signal determining process in position (C) (step D6). The error signal determining process is carried out according to the flowchart of FIG. 6.

After having finished the error signal determining process in position (C), the CPU 25 determines the best method for a tracking error signal in the present position of the optical pickup head 11 on the basis of the result of determining the tracking error signals in position (A), position (B), and position (C) (step D7).

FIG. 8 shows the relationship between the result of determining the tracking error signals generated in position (A), position (B), and position (C) and the method of the tracking error signal selected when the result of the determination was obtained.

FIG. 8 shows a tracking error signal to be selected according to the result of determining whether the amplitude of a tracking error signal is larger or smaller than the threshold value in position (A), position (B), and position (C) in the DPD mode and in the DPP mode.

In FIG. 8, in at least two adjacent ones of position (A), position (B), and position (C), if the amplitude of the tracking error signal is larger than the threshold value in either the DPD mode or the DPP mode, a tracking error signal in that mode is selected. If both modes meet the condition, the DPP method is selected. If none of the modes meet the condition, the DPP method is still selected.

As described above, any one of the tracking error signals generated by the DPP method or DPD method is selected on the basis of the state of the tracking error signals generated in many positions (here, three positions) in the radial direction of the optical disc 10, thereby making it possible to select a suitable tracking error signal more reliably.

In the tracking error type selecting process in the flowchart of FIG. 7, when a tracking error signal of either method can be selected from the result of the tracking error signal determining process in position (A) and position (B), the tracking error type selecting process is completed at that time, which does not require more processing time than necessary.

Moreover, an error signal determining process may be carried out in each of the three positions and then, on the basis of the result of the determination, a tracking error signal may be selected as in FIG. 8.

While in the tracking error type selecting process shown in the flowchart of FIG. 7, an error signal determining process is carried out earlier in position (A) (a first position) serving as the initial position and in position (B) (a second position) located closer to the outer edger than position (A), an error signal determining process may be carried out earlier in position (A) and position (C) (a third position) located closer to the inner edge than position (A).

Moreover, while an error signal determining process is carried out earlier in position A (the first position) and position (B) (the second position) located closer to the outer edge than position (A) and then position (C) is set closer to the inner edge opposite to position (B) with position (A) as a reference, position (C) may be set in the same direction as position (B). That is, position (C) is set at a different distance from position (B) in the radial direction of the optical disc 10. In this case, not only may position (B) and position (C) be set closer to the outer edge, but position (B) and position (C) may also set closer to the inner edge with respect to position (A).

In the above explanation, while the tracking error signals in three places in the radial direction of the optical disc 10 have been determined, tracking error signals in four or more places may be determined.

Moreover, in the above explanation, while the optical pickup head 11 has been tilted, thereby generating the tracking error signals in a plurality of places on the optical disc 10, the position of the laser light from the optical pickup head 11 may be moved to a plurality of places in the radial direction by driving the sled motor 22 or tracking actuator, thereby generating tracking error signals in the respective places.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk apparatus which reproduces and records information by causing an optical pickup head to irradiate laser light onto an optical disk on which tracks have been formed, the optical disk apparatus comprising:
light detecting unit configured to output a light detecting signal on the basis of the reflected light from the optical disk caused by the laser light irradiated by the optical pickup head;
a plurality of tracking error signal generating unit configured to generate a plurality of tracking error signals by different methods on the basis of the light detecting signal output from the light detecting unit;
driving configured to drive the optical pickup head in such a manner that the laser light is irradiated to different positions on the optical disk; and
control configured to select a tracking error signal that fulfills a specific condition from said plurality of tracking error signals in the different methods generated by said plurality of tracking error signal generating unit for each of the different positions on the optical disk and performing tracking control using the selected tracking error signal.

2. The optical disk apparatus according to claim 1, wherein the driving unit causes the optical pickup head to irradiate the laser light to a different place on the optical disk by causing the optical pickup head to move along the radius of the optical disk or tilt.

3. The optical disk apparatus according to claim 1, wherein the control unit selects a tracking error signal in a predetermined specific method, if none of said plurality of tracking error signals in the different methods for each of the different positions generated by said plurality of tracking error signal generating unit fulfill the specific condition.

4. The optical disk apparatus according to claim 1, wherein the control unit causes the driving unit to drive the optical pickup head to irradiate the laser light to still one other different position on the optical disk, if none of said plurality of tracking error signals in the different methods for each of the different positions generated by said plurality of tracking error signal generating means fulfill the specific condition, and
selects a tracking error signal that fulfills the specific condition, taking into account said plurality of tracking error signals in the different methods at the one other different position.

5. The optical disk apparatus according to claim 1, wherein the driving unit drives the optical pickup head in such a manner that the laser light is irradiated to any one of a first position set as an initial position, a second position located in the direction of the radius of the optical disk with respect to the first position, and a third position located in the direction of the radius of the optical disk with respect to the first position or the second position.

6. The optical disk apparatus according to claim 1, wherein the driving unit drives the optical pickup head in such a manner that the laser light is irradiated to any one of a first position set as an initial position, a second position located closer to the outer edge of the optical disk than the first position, and a third position located closer to the inner edge of the optical disk than the first position.

7. A tracking error signal selecting method for an optical disk apparatus comprising:
a first tracking error signal generating step of causing an optical pickup head to irradiate laser light to a first position on an optical disk and generating a plurality of tracking error signals by different methods from a light detecting signal obtained by detecting the reflected light from the optical disk;
a step of driving the optical pickup head to a second position located in the direction of the radius of the optical disk with respect to the first position on the optical disk;
a second tracking error signal generating step of causing the optical pickup head to irradiate laser light to the second position on the optical disk and generating a plurality of tracking error signals by the different methods from the light detecting signal obtained by detecting the reflected light from the optical disk; and
a step of selecting a tracking error signal that fulfills a specific condition from said plurality of tracking error signals obtained in the first and second tracking error signal generating steps and performing tracking control using the selected tracking error signal.

8. The tracking error signal selecting method for an optical disk apparatus according to claim 7, further comprising:
a step of driving the optical pickup head to a third position located in the direction of the radius of the optical disk with respect to the first or second position on the optical disk, if none of said plurality of tracking error signals obtained in the first and second tracking error signal generating steps fulfill the specific condition;
a third tracking error signal generating step of causing the optical pickup head to irradiate laser light to the third position on the optical disk and generating a plurality of tracking error signals by the different methods from the light detecting signal obtained by detecting the reflected light from the optical disk; and
a step of selecting a tracking error signal that fulfills the specific condition from said plurality of tracking error signals obtained in the first to third tracking error signal generating steps and performing tracking control using the selected tracking error signal.

9. A tracking error signal selecting method for an optical disk apparatus comprising:
a first tracking error signal generating step of causing an optical pickup head to irradiate laser light to a first position on an optical disk and generating a plurality of tracking error signals by different methods from a light detecting signal obtained by detecting the reflected light from the optical disk;
a step of driving the optical pickup head to a second position located in the direction of the radius of the optical disk with respect to the first position on the optical disk;
a second tracking error signal generating step of causing the optical pickup head to irradiate laser light to the second position on the optical disk and generating a plurality of tracking error signals by the different methods from the light detecting signal obtained by detecting the reflected light from the optical disk;
a step of driving the optical pickup head to a third position located in the direction of the radius of the optical disk with respect to the first or second position on the optical disk;
a third tracking error signal generating step of causing the optical pickup head to irradiate laser light to the third position on the optical disk and generating a plurality of tracking error signals by the different methods from the light detecting signal obtained by detecting the reflected light from the optical disk; and
a step of selecting a tracking error signal that fulfills the specific condition from said plurality of tracking error signals obtained in the first to third tracking error signal generating steps and performing tracking control using the selected tracking error signal.
